(19) United States
(12) Patent Application Publication
(10) Pub. No.: US 2026/0258204 A1
(43) Pub. Date: Sep. 3, 2026

(54) FLAME-RETARDANT METAL-RESIN COMPOSITE MATERIAL

(71) Applicant: MITSUBISHI CHEMICAL INFRATEC CO., LTD., Tokyo (JP)

(72) Inventors: Kazuhiro MURAKI, Tokyo (JP); Masato HARADA, Tokyo (JP)

(73) Assignee: MITSUBISHI CHEMICAL INFRATEC CO., LTD., Tokyo (JP)

(21) Appl. No.: 19/656,920

(22) Filed: Apr. 23, 2026

Related U.S. Application Data
(63) Continuation of application No. PCT/JP2025/028231, filed on Aug. 8, 2025.

(30) Foreign Application Priority Data
Aug. 8, 2024 (JP) 2024-133181

(51) Int. Cl. C08J 3/00; B32B 27/06; B32B 27/12; B32B 27/30; B32B 27/34; B32B 37/10; B32B 37/12; C08J 3/20; C08K 3/22; C08K 3/26; C08K 5/52

(52) U.S. Cl. CPC C08J 3/005; B32B 27/06; B32B 27/12; B32B 27/306; B32B 27/34; B32B 37/10; B32B 37/12; C08J 3/203; C08K 3/22; C08K 3/26; C08K 5/5205; B32B 2307/3065; B32B 2329/06; B32B 2331/04; B32B 2377/00; C08J 2329/04; C08J 2331/04; C08J 2377/00; C08K 2003/2217; C08K 2003/2227; C08K 2003/265; C08K 2003/267

(57) ABSTRACT

The flame-retardant metal-resin composite material of the present disclosure is a metal-resin composite material including a core material layer and metal layers stacked on both surfaces of the core material layer. The core material layer contains: a metal hydroxide; a resin having a specific polar group; and a flame retardant containing at least one selected from the group consisting of an inorganic polyphosphate compound, an inorganic phosphite compound, an inorganic phosphinate compound, an inorganic metaphosphate compound, a melamine compound, and a triazine compound.

This Nonprovisional application claims priority under 35 U.S.C. § 119 on Patent Application No. 2024-filed in Japan on Aug. 8, 2024, the entire contents of which are hereby incorporated by reference.

### TECHNICAL FIELD

The present invention relates to a flame-retardant metal-resin composite material. In particular, the present invention relates to a flame-retardant metal-resin composite material that is suitable as an exterior construction material and that is configured by using a resin layer containing a metal hydroxide as a core material sheet and joining metal sheets to both surfaces of the core material sheet.

### BACKGROUND ART

A flame-retardant metal-resin composite material configured by using a resin layer containing an inorganic filler as a core material sheet and joining metal sheets to both surfaces of the core material sheet is a material having a combination of numerous features such as lightweight properties, corrosion resistance, heat insulation, flame retardancy, weather resistance, good surface appearance, and metal-like workability. However, the above-mentioned composite material is not fully satisfactory as an exterior construction material such as an exterior wall material for buildings.

Exterior construction materials are required to have flame retardancy as a desirable physical property, and the development of flame-retardant metal-resin composite materials with improved flame retardancy has been advanced.

For example, Patent Literature 1 discloses a flame-retardant metal-resin composite material, which is a metal-resin composite material in which metal layers are stacked on both surfaces of a core material layer containing a resin, the core material layer containing a metal hydroxide and a resin, the core material layer having a combustion calorific value of not more than 2.0 MJ/kg, the metal-resin composite material having a surface material peel strength of not less than 2.4 N/mm.

### CITATION LIST

### Patent Literature

### [Patent Literature 1]

International Publication No. WO 2019/159929

### SUMMARY OF INVENTION

### Technical Problem

Flame retardancy evaluation tests for flame-retardant metal-resin composite materials such as exterior construction materials differ from country to country. The flame-retardant metal-resin composite material disclosed in Patent Literature 1 may not satisfy the flame retardancy required by the flame retardancy evaluation tests of various countries, and further development of a flame-retardant metal-resin composite material with improved flame retardancy has been desired.

An aspect of the present invention is to achieve a flame-retardant metal-resin composite material with improved flame retardancy.

### Solution to Problem

To solve the above-mentioned problem, the present inventors have conducted diligent studies. As a result, they have uniquely developed a test method that can evaluate the flame retardancy required by the flame retardancy evaluation tests of various countries. Then, they have found that a flame-retardant metal-resin composite material containing a specific flame retardant satisfies the criteria for flame retardancy in the test method uniquely developed by the present inventors, and have completed the present invention.
(1) A flame-retardant metal-resin composite material including:
a core material layer; and metal layers stacked on both surfaces of the core material layer, wherein
the core material layer contains
   a metal hydroxide,
   a resin having at least one polar group selected from the group consisting of a hydroxyl group, a carboxyl group, an aldehyde group, an amino group, a glycidyl group, and a ketone group, and
a flame retardant containing at least one selected from the group consisting of an inorganic polyphosphate compound, an inorganic phosphite compound, an inorganic phosphinate compound, an inorganic metaphosphate compound, a melamine compound, and a triazine compound.
(2) The flame-retardant metal-resin composite material in accordance with (1), wherein flaming for not shorter than 1 second does not occur at the core material layer for 120 seconds after the core material layer has been placed in an electric furnace and for 120 seconds after the core material layer has been taken out from the electric furnace in the following combustion test:

### [Combustion Test]

a core material layer test piece of 38 mm in length, 38 mm in width, and 3 mm in height is placed in an electric furnace having a heater output of 500 W, internal furnace dimensions of 90 mm×110 mm×70 mm, and an inside controlled to 800° C. so that a 38 mm×38 mm surface of the core material layer test piece is substantially perpendicular to a bottom surface of the inside of the electric furnace.
(3) The flame-retardant metal-resin composite material in accordance with (1) or (2), wherein the metal-resin composite material has a surface material peel strength of not less than 2.4 N/mm.
(4) The flame-retardant metal-resin composite material in accordance with any one of (1) to (3), wherein the resin is at least one resin selected from the group consisting of a polyvinyl alcohol-based resin, a polyamide-based resin, a modified polyolefin-based resin, an olefin-based copolymer, an acrylic resin, a polyurethane-based resin, and an epoxy-based resin.
(5) The flame-retardant metal-resin composite material in accordance with any one of (1) to (4), further including an adhesive layer between the core material layer and each of the metal layers, wherein the adhesive layer contains a resin having at least one polar group selected from the group consisting of a hydroxyl group, a carboxyl group, an aldehyde group, an amino group, a glycidyl group, and a ketone group.
(6) The flame-retardant metal-resin composite material in accordance with (5), wherein the resin contained in the adhesive layer is at least one resin selected from the group consisting of a polyvinyl alcohol-based resin, a polyamide-based resin, a modified polyolefin-based resin, an olefin-based copolymer, an acrylic resin, a polyurethane-based resin, and an epoxy-based resin.
(7) The flame-retardant metal-resin composite material in accordance with any one of (1) to (6), containing 1 to 15 parts by mass of the flame retardant with respect to 100 parts by mass of the core material layer.
(8) The flame-retardant metal-resin composite material in accordance with any one of (1) to (7), containing 1 part by mass to 10 parts by mass of the resin with respect to 100 parts by mass of the core material layer.
(9) The flame-retardant metal-resin composite material in accordance with any one of (1) to (8), containing 30 parts by mass to 95 parts by mass of the metal hydroxide with respect to 100 parts by mass of the core material layer.
(10) The flame-retardant metal-resin composite material in accordance with any one of (1) to (9), further including a layer made of a non-woven fabric.

### Advantageous Effects of Invention

An aspect of the present invention makes it possible to provide a flame-retardant metal-resin composite material with improved flame retardancy.

### DESCRIPTION OF EMBODIMENTS

Hereinafter, an aspect of the present invention will be described in detail, but the present invention is not limited to the following aspects without departing from the object thereof. In the present specification, the expression “to” includes the lower and upper limits. In addition, for each preferable range, the upper and lower limits can be used in any combination.

A flame-retardant metal-resin composite material according to an aspect of the present invention is a metal-resin composite material including a core material layer containing a resin and metal layers stacked on both surfaces of the core material layer. In the present specification, “metal layers stacked on both surfaces of a core material layer” means that at least two metal layers are disposed with the core material layer interposed therebetween, and another layer may be provided between the core material layer and each metal layer. Examples of the other layer include an adhesive layer described later.

### <Core Material Layer>

The core material layer of the flame-retardant metal-resin composite material according to an aspect of the present invention contains at least a resin, a metal hydroxide, and a flame retardant. Hereinafter, the resin contained in the core material layer may be referred to as a core material resin.

### [Core Material Resin]

The core material resin contained in the flame-retardant metal-resin composite material in accordance with an aspect of the present invention is a resin having at least one polar group selected from the group consisting of a hydroxyl group, a carboxyl group, an aldehyde group, an amino group, a glycidyl group, and a ketone group. By having a polar group, the core material resin has an increased interaction with the metal hydroxide. One or more kinds of the core material resin can be used.

Examples of the resin having a polar group include a polyvinyl alcohol-based resin, a polyamide-based resin, a modified polyolefin-based resin, an olefin-based copolymer, an acrylic resin, a polyurethane-based resin, and an epoxy-based resin. One or more of these resins can be used.

Among these, a polyvinyl alcohol-based resin, a polyamide-based resin, or an olefin-based copolymer is preferable, and a polyvinyl alcohol-based resin is more preferable, due to their excellent inorganic filler chargeability.

Examples of the polyvinyl alcohol-based resin include a polyvinyl alcohol resin, a modified polyvinyl alcohol resin containing 1 mol % to 50 mol % of an α-olefin unit having not more than four carbon atoms, or a polyvinyl acetal resin (such as a polyvinyl butyral resin).

For further improving the flame retardancy of the flame-retardant metal-resin composite material, the polyvinyl alcohol-based resin is preferably a modified polyvinyl alcohol resin containing 1 mol % to 50 mol % of an α-olefin unit having not more than four carbon atoms or a polyvinyl acetal resin (such as a polyvinyl butyral resin), and more preferably a polyvinyl butyral resin (hereinafter, may be referred to as PVB).

Examples of the polyamide-based resin include aliphatic polyamides such as polyamide 6, polyamide 66, polyamide 612, polyamide 11, polyamide 12, and polyamide 1010; and semi-aromatic polyamides such as polyamide 4T (a copolymer of 1,4-butanediamine and terephthalic acid), polyamide 6T (a copolymer of 1,6-hexanediamine and terephthalic acid), polyamide MXD6 (a copolymer of meta-xylenediamine and adipic acid), polyamide 61 (a copolymer of 1,6-hexanediamine and isophthalic acid), and polyamide 9T (a copolymer of 1,9-nonanediamine and terephthalic acid).

Examples of the modified polyolefin-based resin include unsaturated carboxylic acid graft-modified polyolefin-based resins such as maleic anhydride graft-modified polyolefin-based resins such as a maleic anhydride graft copolymer of polyethylene or a maleic anhydride graft copolymer of an ethylene-propylene copolymer, or (meth)acrylic acid graft-modified polyolefin-based resins such as an acrylic acid graft copolymer of polyethylene.

Examples of the olefin-based copolymer include ethylene-based copolymers such as an ethylene-(meth)acrylic acid (ester) copolymer, an ethylene-vinyl acetate copolymer, an ethylene-glycidyl acrylate copolymer, and an ethylene-maleic anhydride copolymer.

Examples of the acrylic resin include a resin that has at least a (meth)acrylic acid (ester) unit as a constitutional unit and that may have, for example, a monomer unit such as styrene, acrylonitrile, methyl vinyl ketone, vinyl acetate, methallyl alcohol, allyl alcohol, 2-hydroxymethyl-1-butene, N-vinylpyrrolidone, or N-vinylcarbazole as a constitutional unit other than a (meth)acrylic acid (ester) monomer.

Examples of the polyurethane-based resin include a resin in which a polyol component such as an alkylene glycol or a polyester polyol and a diisocyanate component such as an aromatic diisocyanate, an aliphatic diisocyanate, or an alicyclic diisocyanate undergo polyaddition to form a polyurethane bond.

Examples of the epoxy-based resin include an alicyclic epoxy resin having a skeleton derived from an alicyclic compound, an epoxy resin having a glycidyl ether group, and an epoxy resin having an aromatic group.

In a case where the core material resin is an ethylene-based copolymer such as an ethylene-(meth)acrylic acid (ester) copolymer or an ethylene-vinyl acetate copolymer, the content ratio of constitutional units other than ethylene (for example, (meth)acrylic acid (ester) units or vinyl acetate units) is preferably not less than 10 mass %, more preferably not less than 15 mass %, still more preferably not less than 17.5 mass %, and particularly preferably not less than 20 mass %. The upper limit of the content ratio of constitutional units other than ethylene is not limited, but the content ratio is usually not more than 90 mass %, preferably not more than 80 mass %, and more preferably not more than 70 mass %.

In a case where the core material resin is a polyvinyl alcohol-based resin, the hydroxyl group mass concentration (mass % of vinyl alcohol units in the resin) of the polyvinyl alcohol-based resin is preferably 10 mass % to 40 mass %. It is more preferably 15 mass % to 40 mass % and still more preferably 15 mass % to 25 mass % (for example, 15, 20, or 25 mass %) in order to obtain a multilayer structure having excellent interlayer adhesive strength.

The hydroxyl group mass concentration of the polyvinyl alcohol-based resin can be measured according to JIS K6728 “Testing methods for polyvinyl butyral”. For example, a certain amount of the polyvinyl alcohol-based resin is weighed, and the hydroxyl group in the polyvinyl alcohol-based resin is acetylated with use of a mixed solution of acetic anhydride and pyrimidine, and titrated with a sodium hydroxide solution. The hydroxyl group mass concentration can be calculated by multiplying, by the molecular weight of the hydroxyl group-containing unit, the number of moles of sodium hydroxide consumed.

The core material resin may be reacted with a modifying agent such as an unsaturated carboxylic acid to cause modification.

The combustion calorific value of the core material resin is not particularly limited, but is preferably not more than 40 MJ/kg, more preferably not more than 38 MJ/kg, and still more preferably not more than 35 MJ/kg. The combustion calorific value is measured by a method according to the test method of ISO 1716 (2018 edition). The method according to the test method of ISO 1716 (2018 edition) is a method using an adiabatic bomb calorimeter or an automatic bomb calorimeter.

The tensile strength of the core material resin is not particularly limited, but is preferably not less than 30 MPa, more preferably not less than 35 MPa, and still more preferably not less than 40 MPa. A tensile strength of not less than 30 MPa is preferable since the entanglement with the main chain of the resin contained in the adhesive layer described later becomes stronger, thereby increasing the surface material peel strength of the composite material. The tensile strength is measured by “Plastics-Determination of tensile properties” according to the test method of ISO 527-1 (2019 edition).

The melt viscosity of the core material resin is not particularly limited, but is preferably not more than 3,000 Pa·s, more preferably not more than 2,000 Pa·s, and still more preferably not more than 1,000 Pa·s. The lower limit of the melt viscosity of the core material resin is not particularly limited, but the melt viscosity is usually not less than 10 Pa·s, preferably not less than 30 Pa·s, and more preferably not less than 50 Pa·s. When the melt viscosity of the core material resin is not more than 3,000 Pa·s, the resin is likely to be present at the interface between the adhesive layer described later and the core material layer during heat molding in the manufacturing process, and the adhesive strength between the core material layer and the metal layer is improved. The range of the melt viscosity of the core material resin is preferably 30 Pa·s to 3000 Pa·s, more preferably 30 Pa·s to 2,000 Pa·s, and still more preferably 50 Pa·s to 1,000 Pa·s (for example, 50, 100, 200, 300, 400, 500, 600, 700, 800, 900, or 1,000 Pa·s).

The melt viscosity is a value at a temperature of 200° C. and a shear rate of 100 [1/sec], and is measured by a test method for the fluidity of plastics using “Plastics—Determination of the fluidity of plastics using capillary and slit-die rheometers” according to the test method of ISO 11443 (2021 edition).

A preferable core material resin is a resin having a combustion calorific value of not more than 40 MJ/kg, a tensile strength of not less than 30 MPa, and a melt viscosity of not more than 3,000 Pa·s. By setting the combustion calorific value, tensile strength, and melt viscosity of the core material resin within the above ranges, the flame retardancy and peel strength of the composite material can be increased even with a small amount of resin contained in the core material layer.

The weight average molecular weight (Mw) of the core material resin is preferably not less than 5.0×10³, more preferably not less than 1.0×10⁴, and still more preferably not less than 2.0×10⁴. The upper limit of the weight average molecular weight of the core material resin is not limited, but the weight average molecular weight is usually not more than 1.0×10⁵, and preferably not more than 8.0×10⁴. The range of the weight average molecular weight of the core material resin is preferably 5.0×10³ to 8.0×10⁴, more preferably 1.0×10⁴ to 8.0×10⁴, and still more preferably 2.0×10⁴ to 8.0×10⁴ (for example, 2.0×10⁴, 3.0×10⁴, 4.0×10⁴, 5.0×10⁴, 6.0×10⁴, 7.0×10⁴, or 8.0×10⁴).

The weight average molecular weight can be measured by a GPC method, for example, under the following measurement conditions.
Measurement device: HLC-8320GPC (manufactured by TOSOH CORPORATION)
Column: Four TSKgel GMH_{XL} (manufactured by TOSOH CORPORATION) columns
Eluent: THF
Measurement temperature: 40° C.
Eluent flow rate: 1 ml/min
Sample concentration: 1 mg/ml
Injection volume: 100 μl

The ratio (Mw/Mn) of the weight average molecular weight (Mw) to the number average molecular weight (Mn) of the core material resin is usually not less than 0.5, preferably not less than 1.0, and more preferably not less than 1.5. The upper limit of the ratio of the weight average molecular weight to the number average molecular weight of the core material resin is not limited, but the ratio is usually not more than 5.0, preferably not more than 4.0, and more preferably not more than 3.0. The number average molecular weight is measured by the same method as that for the weight average molecular weight. The range of Mw/Mn of the core material resin is preferably 1.0 to 4.0, and more preferably 1.5 to 3.0 (for example, 1.5, 2.0, 2.5, or 3.0).

From the viewpoint of inorganic filler chargeability, the amount of the core material resin contained in the flame-retardant metal-resin composite material in accordance with an aspect of the present invention is preferably not less than 1 part by mass, more preferably not less than 2 parts by mass, and still more preferably not less than 3 parts by mass, with respect to 100 parts by mass of the core material layer. For suppressing the combustion calorific value of the core material layer, the amount of the core material resin contained is preferably not more than 10 parts by mass, more preferably not more than 9 parts by mass, and still more preferably not more than 8 parts by mass, with respect to 100 parts by mass of the core material layer. The range of the amount of the core material resin contained is preferably 1 part by mass to 10 parts by mass, more preferably 2 parts by mass to 9 parts by mass, and still more preferably 3 parts by mass to 8 parts by mass (for example, 3, 4, 5, 6, 7, or 8 parts by mass), with respect to 100 parts by mass of the core material layer.

### [Metal Hydroxide]

The metal hydroxide contained in the flame-retardant metal-resin composite material in accordance with an aspect of the present invention is not particularly limited, provided that it can absorb thermal energy through decomposition of hydroxyl groups. One or more kinds of the metal hydroxide can be used.

For further improving the flame retardancy of the flame-retardant metal-resin composite material, the metal hydroxide is preferably an inorganic metal hydroxide, more preferably a hydroxide of a trivalent metal or a hydroxide of an alkaline earth metal, still more preferably magnesium hydroxide, aluminum hydroxide, or calcium hydroxide, and particularly preferably aluminum hydroxide.

The average particle size of the metal hydroxide is not particularly limited, but is usually 0.1 μm to 200 μm, preferably 20 μm to 180 μm, and more preferably 50 μm to 150 μm (for example, 50, 100, or 150 μm). Setting the particle size of the metal hydroxide within the above range is preferable since the dispersibility of the metal hydroxide in the core material layer is high and the peel strength of the metal-resin composite material is improved. The average particle size of the metal hydroxide is measured by a Microtrac method.

For further improving the flame retardancy of the flame-retardant metal-resin composite material, the amount of the metal hydroxide contained in the flame-retardant metal-resin composite material in accordance with an aspect of the present invention is preferably not less than 30 parts by mass, more preferably not less than 40 parts by mass, and still more preferably not less than 50 parts by mass, with respect to 100 parts by mass of the core material layer. For ensuring the surface material peel strength of the metal-resin composite material, the amount of the metal hydroxide contained is preferably not more than 95 parts by mass, and more preferably not more than 93 parts by mass, with respect to 100 parts by mass of the core material layer. The range of the amount of the metal hydroxide contained is preferably 30 parts by mass to 95 parts by mass (for example, 30, 35, 40, 45, 50, 55, 60, 65, 70, 75, 80, 85, 90, or 95 parts by mass), more preferably 40 parts by mass to 93 parts by mass, and still more preferably 50 parts by mass to 93 parts by mass, with respect to 100 parts by mass of the core material layer.

### [Flame Retardant]

The flame retardant contained in the flame-retardant metal-resin composite material in accordance with an aspect of the present invention contains at least one selected from the group consisting of an inorganic polyphosphate compound, an inorganic phosphite compound, an inorganic phosphinate compound, an inorganic metaphosphate compound, a melamine compound, and a triazine compound.

Examples of the inorganic polyphosphate compound include metal polyphosphates such as ammonium polyphosphate, aluminum polyphosphate, sodium polyphosphate, and calcium polyphosphate. In the present specification, polyphosphoric acid includes, for example, pyrophosphoric acid, triphosphoric acid, and tetraphosphoric acid.

Examples of the inorganic phosphite compound include metal phosphites such as aluminum phosphite, sodium phosphite, and calcium phosphite.

Examples of the inorganic phosphinate compound include metal phosphinates such as aluminum phosphinate, sodium phosphinate, and calcium phosphinate.

Examples of the inorganic metaphosphate compound include metal metaphosphates such as aluminum metaphosphate, sodium metaphosphate, and calcium metaphosphate.

For further improving flame retardancy, among the inorganic polyphosphate compound, the inorganic phosphite compound, the inorganic phosphinate compound, and the inorganic metaphosphate compound, the inorganic polyphosphate compound is preferable, ammonium polyphosphate and metal polyphosphate are more preferable, and ammonium polyphosphate is still more preferable.

Examples of the melamine compound include: reaction products of a phosphoric acid-based compound and melamine, such as melamine phosphate, melamine polyphosphate, melamine orthophosphate, melamine phosphite, melamine hypophosphite, melamine metaphosphate, and melamine polymetaphosphate; melamine; melamine cyanurate; melamine sulfate; melamine nitrate; and melamine borate. The melamine compound may be a condensate of melamine (for example, melam, melem, or melon).

For further improving flame retardancy, the melamine compound is preferably a reaction product of a phosphoric acid compound and melamine, melamine cyanurate, or melamine sulfate, and more preferably melamine polyphosphate, melamine cyanurate, or melamine sulfate.

Examples of the triazine compound include triazine ring-containing compounds such as cyanuric acid, acetoguanamine, and benzoguanamine.

The reason why the flame retardancy of the flame-retardant metal-resin composite material in accordance with an aspect of the present invention is improved is not sufficiently clear, but is presumed to be due to the following mechanism. The flame retardant contained in the flame-retardant metal-resin composite material has a feature of excellent dispersibility in the core material resin. Due to this feature, the use of the flame retardant exhibits an excellent effect of improving flame retardancy in the flame-retardant metal-resin composite material in accordance with an aspect of the present invention. In addition, an excellent effect of making it less likely that the adhesive strength between the core material layer and the metal layer decreases in the flame-retardant metal-resin composite material is exerted.

For ensuring flame retardancy, the amount of the flame retardant contained in the flame-retardant metal-resin composite material in accordance with an aspect of the present invention is preferably not less than 1 part by mass, more preferably not less than 2 parts by mass, and still more preferably not less than 3 parts by mass, with respect to 100 parts by mass of the core material layer. For suppressing the combustion calorific value of the core material layer, the amount of the flame retardant contained is preferably not more than 15 parts by mass, more preferably not more than 13 parts by mass, and still more preferably not more than 12 parts by mass, with respect to 100 parts by mass of the core material layer. The range of the amount of the flame retardant contained is preferably 1 part by mass to 15 parts by mass, more preferably 2 parts by mass to 13 parts by mass, and still more preferably 3 parts by mass to 12 parts by mass (for example, 3, 4, 5, 6, 7, 8, 9, 10, 11, or 12 parts by mass), with respect to 100 parts by mass of the core material layer.

### [Other Components]

The core material layer may comprise one or more other components such as a filler, a silane coupling agent, a dispersant, a lubricant, a non-woven fabric, a processing aid, a curing agent, a release agent, a pigment, a weathering agent, an antioxidant, a plasticizer, a sliding agent, and a foaming agent, provided that the effects of the present invention are not impaired.

Examples of the filler include a fibrous filler, a particulate filler, and a plate-like filler. The fibrous filler is a filler having a fibrous shape. The plate-like filler is a filler having a plate-like shape. The particulate filler is a filler having a shape, including an irregular shape, other than fibrous or plate-like shapes.

Examples of the fibrous filler include fibrous inorganic fillers such as glass fiber, carbon fiber, asbestos fiber, metal fiber, wollastonite, attapulgite, sepiolite, rock wool, aluminum borate whisker, potassium titanate fiber, calcium carbonate whisker, titanium oxide whisker, and ceramic fiber; and fibrous organic fillers such as aramid fiber, polyimide fiber, and polyparaphenylene benzobisoxazole fiber. One or more of these can be used.

Examples of the plate-like filler and the particulate filler include talc, kaolin clay, calcium carbonate, zinc oxide, calcium silicate hydrate, mica, glass beads (which may be hollow), glass flakes, glass powder, magnesium carbonate, silica, titanium oxide, alumina, barium sulfate, calcium sulfate, calcium sulfite, zinc borate, barium metaborate, aluminum borate, calcium borate, sodium borate, aluminum nitride, boron nitride, silicon nitride, and pulverized products of the above-mentioned fibrous fillers. One or more of these can be used.

The filler is preferably an inorganic filler, and more preferably one or more selected from glass fiber, carbon fiber, glass beads, calcium carbonate, and magnesium carbonate. When such a filler is used, the mechanical strength of the core material layer can be particularly improved.

The filler may be surface-treated with a coupling agent such as a silane coupling agent.

Examples of the dispersant include saturated fatty acid metal salts such as zinc stearate.

Examples of the lubricant include esters or amides of saturated fatty acids.

As the processing aid, an acrylic resin, a polyimide-based resin, or a polyolefin-based resin is used, and a modified acrylic resin is preferably used.

As the non-woven fabric, a known non-woven fabric can be used. By including a non-woven fabric in the core material layer, the shape of the core material layer is stabilized, thereby making it possible to, for example, store and transport the core material layer in a roll form.

For obtaining a flame-retardant metal-resin composite material with further improved flame retardancy and high surface material peel strength, it is preferable that the core material layer contains 1 part by mass to 15 parts by mass of the flame retardant, 1 part by mass to 10 parts by mass of the resin, 30 parts by mass to 95 parts by mass of the metal hydroxide, and 0 parts by mass to 45 parts by mass of the other components.

### (Physical Properties of Core Material Layer)

The core material layer has flame retardancy such that in the following combustion test, flaming for not shorter than 1 second does not occur for 120 seconds after the core material layer has been placed in an electric furnace and for 120 seconds after the core material layer has been taken out from the electric furnace.

### [Combustion Test]

A core material layer test piece of 38 mm in length, 38 mm in width, and 3 mm in height is placed in an electric furnace having a heater output of 500 W, internal furnace dimensions of 90 mm×110 mm×70 mm, and an inside controlled to 800° C. so that a 38 mm×38 mm surface of the core material layer test piece is substantially perpendicular to a bottom surface of the inside of the electric furnace.

In the present specification, “flaming” indicates a state in which a flame is continuously burning after ignition.

The core material layer in the flame-retardant metal-resin composite material in accordance with an aspect of the present invention can be obtained by molding a composition for a core material layer obtained by mixing the components constituting the core material layer.

From the viewpoint of the dispersion state of the core material resin and the filler, the specific gravity of the composition for a core material layer after sheet molding is usually not less than 1.6, and preferably not less than 1.7. The upper limit of the specific gravity of the composition for a core material layer after sheet molding is usually not more than 2.5, preferably not more than 2.3, more preferably not more than 2.1, and still more preferably not more than 2.0. The range of the specific gravity is preferably 1.6 to 2.3, more preferably 1.6 to 2.1, and still more preferably 1.7 to 2.0 (for example, 1.7, 1.8, 1.9, or 2.0).

The thickness of the core material layer is not particularly limited, but is usually 1.0 mm to 8.0 mm, preferably 1.3 mm to 8.0 mm, more preferably 2.0 mm to 8.0 mm, still more preferably 2.0 mm to 6.0 mm, and particularly preferably 2.0 mm to 5.0 mm (for example, 2.0, 2.5, 3.0, 3.5, 4.0, 4.5, or 5.0 mm).

### <Metal Layer>

Examples of the metal layer in the flame-retardant metal-resin composite material in accordance with an aspect of the present invention include a layer made of a metal such as aluminum, stainless steel, iron, copper, titanium, tin, or nickel, or various alloys. The metal layer is preferably a layer made of aluminum, stainless steel, or iron, and more preferably a layer made of aluminum.

Considering the strength against external forces to be applied to the flame-retardant metal-resin composite material, the thickness of the metal layer is preferably 0.1 mm to 0.8 mm (for example, 0.1, 0.2, 0.3, 0.4, 0.5, 0.6, 0.7, or 0.8 mm).

### <Adhesive Layer>

It is preferable that the flame-retardant metal-resin composite material in accordance with an aspect of the present invention further comprise an adhesive layer between the core material layer and each metal layer. The adhesive layer preferably contains a resin having at least one polar group selected from the group consisting of a hydroxyl group, a carboxyl group, an aldehyde group, an amino group, a glycidyl group, and a ketone group, in order to have affinity for both the core material layer and the metal layer.

Examples of the resin having a polar group include a polyvinyl alcohol-based resin, a polyamide-based resin, a modified polyolefin-based resin, an olefin-based copolymer, an acrylic resin, a polyurethane-based resin, and an epoxy-based resin. One or more of these resins can be used.

Examples of the resin contained in the adhesive layer are the same as the examples of the resin contained in the core material layer. The resin contained in the adhesive layer may be the same as or different from the resin contained in the core material layer.

Among these, a polyvinyl alcohol-based resin, a polyamide-based resin, or an olefin-based copolymer is preferable, and an olefin-based copolymer is more preferable, due to their excellent adhesiveness between the resin and the metal.

The adhesive layer is preferably formed on the metal layer in advance, and then joined with the core material layer.

The thickness of the adhesive layer is not particularly limited, but is usually 5 μm to 100 μm, preferably 10 μm to 80 μm, and more preferably 20 μm to 60 μm (for example, 20, 30, 40, 50, or 60 μm).

### <Other Layers>

The flame-retardant metal-resin composite material in accordance with an aspect of the present invention may further include other layers, such as a layer made of a non-woven fabric. For example, a layer made of a non-woven fabric may be disposed between the core material layer and the metal layer. As the non-woven fabric, a conventionally known non-woven fabric can be used, and for example, the non-woven fabric disclosed in US 2023/0044998 A1 can be used.

### <Physical Properties of Flame-Retardant Metal-Resin Composite Material>

The flame-retardant metal-resin composite material in accordance with an aspect of the present invention has a surface material peel strength of not less than 2.4 N/mm, preferably not less than 3.1 N/mm, and more preferably not less than 3.9 N/mm, as measured according to the test method of ISO 8510-2.

The bending strength of the flame-retardant metal-resin composite material is usually not less than 50 MPa, and preferably not less than 60 MPa.

The flexural modulus of the flame-retardant metal-resin composite material is usually not less than 5.0×10³ N/mm², and preferably not less than 3.0×10⁴ N/mm², in a case where the metal layer is made of aluminum. The upper limit of the flexural modulus is not limited, but the flexural modulus is usually not more than 7.0×10⁴ N/mm². The range of the flexural modulus of the flame-retardant metal-resin composite material in a case where the metal layer is made of aluminum is preferably 3.0×10⁴ N/mm² to 7.0×10⁴ N/mm² (for example, 3.0×10⁴, 4.0×10⁴, 5.0×10⁴, 6.0×10⁴, or 7.0×10⁴ N/mm²).

In a case where the metal layer is made of stainless steel or iron, the flexural modulus of the flame-retardant metal-resin composite material is usually not less than 1.4×10⁴ N/mm², preferably not less than 3.0×10⁴ N/mm², and usually not more than 2.0×10⁵ N/mm². The range of the flexural modulus of the flame-retardant metal-resin composite material in a case where the metal layer is made of stainless steel or iron is preferably 3.0×10⁴ N/mm² to 2.0×10⁵ N/mm² (for example, 3.0×10⁴, 5.0×10⁴, 7.5×10⁴, 1.0×10⁵, or 2.0×10⁵ N/mm²).

The flexural rigidity of the flame-retardant metal-resin composite material is usually not less than 1.0×10⁷ N·mm², and preferably not less than 1.3×10⁷ N·mm².

The bending strength, flexural modulus, and flexural rigidity of the flame-retardant metal-resin composite material are measured using a central concentrated loading method with two-point support for a sample (width: 60 mm, span: 200 mm) under the condition of a loading speed of 50 mm/min.

The overall thickness of the flame-retardant metal-resin composite material is not particularly limited because it is set as appropriate according to the application of the flame-retardant metal-resin composite material, but is usually not less than 1.5 mm, preferably not less than 2.0 mm, more preferably not less than 2.5 mm, and still more preferably not less than 3.0 mm. The upper limit of the thickness of the flame-retardant metal-resin composite material is not particularly limited, and the thickness may be not more than 50 mm. The range of the overall thickness of the flame-retardant metal-resin composite material is preferably 2.0 mm to 50 mm, more preferably 2.5 mm to 50 mm, and still more preferably 3.0 mm to 50 mm (for example, 3.0, 5.0, 10, 20, 30, 40, or 50 mm).

### <Method for Manufacturing Flame-Retardant Metal-Resin Composite Material>

A method for manufacturing the flame-retardant metal-resin composite material in accordance with an aspect of the present invention will be described. The method for manufacturing the flame-retardant metal-resin composite material in accordance with an aspect of the present invention is not particularly limited, and examples thereof include an injection molding method, a transfer molding method, a compression molding method, and an injection compression molding method. Among these, a compression molding method is particularly suitable.

An example of a method for manufacturing a flame-retardant metal-resin composite material by a compression molding method is as follows.

The core material resin, the flame retardant, and the metal hydroxide, and if necessary, the other components described above are mixed by a conventionally known method, such as a mixer. The composition for a core material layer obtained by mixing (preferably, uniformly mixing the flame retardant, the metal hydroxide, the resin, and the like after heating and kneading to melt the resin) is supplied onto a first metal layer having an adhesive layer. Then, a second metal layer having an adhesive layer is stacked, and is heated and pressurized by a conventionally known method such as a hot press. The adhesive layer of the second metal layer is disposed on a core material layer side. The heating condition is not particularly limited, but is preferably 140 to 200° C., and more preferably 160 to 180° C. (for example, 160, 170, or 180° C.). The pressurizing condition is not particularly limited, but is preferably 300 N/cm² to 1000 N/cm², and more preferably 500 N/cm² to 800 N/cm² (for example, 500, 600, 700, or 800 N/cm²). The holding time is not particularly limited, but is preferably 1 second to 60 seconds, and more preferably 10 seconds to 30 seconds (for example, 10, 20, or 30 seconds). The flame-retardant metal-resin composite material in accordance with an aspect of the present invention is obtained by the above operations.

As a method for manufacturing a flame-retardant metal-resin composite material including a layer made of a non-woven fabric, for example, the manufacturing method disclosed in US 2023/0044998 A1 can be employed.

The present invention is not limited to the above-described aspects, and various modifications can be made within the scope of the claims, and aspects obtained by appropriately combining technical means disclosed as different aspects are also included in the technical scope of the present invention.

### EXAMPLES

One example of the present invention will be described below.

### [Preparation of Materials]

The abbreviations and/or details of the resins used in the following Examples and Comparative Examples are as follows.

### [Resins]

PVB: Polyvinyl alcohol-based resin (polyvinyl butyral, weight average molecular weight (Mw) of 2.1×10⁴, Mw/number average molecular weight (Mn) of 2.3, hydroxyl group mass concentration of 18 mass % to 21 mass %, combustion calorific value of 30.4 MJ/kg, tensile strength of 46 MPa, melt viscosity of 300 Pa·S)
EVA: Ethylene-vinyl acetate copolymer (VA content of 80%, weight average molecular weight (Mw) of 3.0×10⁵, combustion calorific value of 25.2 MJ/kg, tensile strength of 2 MPa, melt viscosity of 400 Pa·S)
Polyamide: Copolymerized polyamide resin (melt viscosity (ISO 1133, 160° C./2.16 kg) of 150 Pa·S)

### [Metal Hydroxide]

Aluminum hydroxide (average particle size of 105 μm)
Magnesium hydroxide (average particle size of 3.5 μm)

### [Inorganic Filler]

CaCO₃ (calcium carbonate)
MgCO₃ (magnesium carbonate)
Lightweight material (inorganic hollow filler containing silicon dioxide as a main component)

### [Flame Retardant]

Melamine polyphosphate (product name: MPP-A, manufactured by Sanwa Chemical Co., Ltd.)
Ammonium polyphosphate (product name: TAIEN K, manufactured by Taihei Chemical Industrial Co., Ltd.)
Melamine cyanurate (product name: MC-6000, manufactured by Nissan Chemical Corporation)
Melamine sulfate (product name: APINON-901, manufactured by Sanwa Chemical Co., Ltd.)
Amine phosphate-metal phosphate composite (product name: FP-2100JC, manufactured by ADEKA CORPORATION)
Guanidine phosphate (product name: APINON-303, manufactured by Sanwa Chemical Co., Ltd.)

### Examples 1 to 20 and Comparative Examples 1 to 6

A flame-retardant metal-resin composite material was manufactured by the following procedure with use of an aluminum sheet with a thickness of 0.5 mm having an adhesive layer (ethylene-maleic anhydride copolymer) with a thickness of 55 μm, and a composition for a core material layer.

### <Preparation of Composition for Core Material Layer>

The components were blended according to the blending ratios shown in Tables 1 to 3, and melt-kneaded at 180° C. to prepare compositions for a core material layer of Examples 1 to 20 and Comparative Examples 1 to 6.

### <Hot Press Molding>

Each composition for a core material layer described above was supplied onto an aluminum sheet having an adhesive layer, and an aluminum sheet having an adhesive layer was further stacked thereon. They were adhered by holding for 10 seconds under a pressure of 500 N/cm² at 180° C. with use of a hot press machine to produce a flame-retardant metal-resin composite material with a thickness of 4 mm.

Next, a combustion test for the composition for a core material layer and a measurement test for the surface material peel strength of the produced flame-retardant metal-resin composite material were performed.

### <Combustion Test>

A test piece of 38 mm in length, 38 mm in width, and 3 mm in height was produced from each composition for a core material layer. For the combustion test, an electric furnace having a heater output of 500 W and internal furnace dimensions of 90 mm×110 mm×70 mm was used. A test piece fixed with use of a wire mesh was placed in the electric furnace with the temperature inside the furnace controlled to 800° C. so that a 38 mm×38 mm surface of the test piece was substantially perpendicular to the bottom surface inside the furnace. Then, the presence or absence of continuous flaming for not shorter than 1 second on the test piece was determined by visual observation by the operator for 120 seconds after the test piece has been placed in the electric furnace and for 120 seconds after the test piece has been taken out from the electric furnace.

### <Measurement of Surface Material Peel Strength>

Measurement was performed by a measurement method according to the test method of ISO 8510-2. A test piece with a width of 25.0 mm±0.5 mm and a minimum length of 150 mm was prepared from the flame-retardant metal-resin composite material. A first metal layer having an adhesive layer was peeled off to about 60% of the length of the test piece. The first metal layer was then clamped with a fixed grip, and the unpeeled side was attached to the other grip. At this time, care was taken to accurately attach the test piece between the grips so that tension was uniformly applied to the width of the test piece. Then, peeling was performed at a speed of 100 mm/min over at least a length of 50 mm. For each test piece, the average surface material peel strength (N) was measured from the force-grip displacement curve over the peel length excluding the first 25 mm.

Tables 1 to 3 show the components in each composition for a core material layer, blending ratios thereof, the evaluation results of the combustion test, and the measurement results of the surface material peel strength of the flame-retardant metal-resin composite material. The unit of the blending ratio of the components in each composition for a core material layer is mass %.

TABLE 1

| | | Exam- | Exam- | Exam- | Exam- | Exam- | Exam- | Exam- | Exam- | Exam- | Exam- | Exam- |
|---|---|---|---|---|---|---|---|---|---|---|---|---|
| | | ple | ple | ple | ple | ple | ple | ple | ple | ple | ple | ple |
| | | 1 | 2 | 3 | 4 | 5 | 6 | 7 | 8 | 9 | 10 | 11 |
| Resin | PVB | 4.6 | 4.3 | 4.6 | 4.6 | 4.6 | 4.6 | 4.6 | 4.6 | 4.6 | 4.6 | 4.6 |
| | EVA | | | | | | | | | | | |
| | Polyamide | | | | | | | | | | | |
| Metal | Aluminum hydroxide | 65.4 | 70.7 | 45.4 | 90.4 | 91.4 | 85.4 | 90.4 | 90.4 | 85.4 | 90.4 | 85.4 |
| hydroxide | Magnesium hydroxide | | | | | | | | | | | |
| Inorganic | CaCO₃ | 20 | 20 | 40 | | | | | | | | |
| filler | MgCO₃ | | | | | | | | | | | |
| | Lightweight material | | | | | | | | | | | |
| Flame | Melamine polyphosphate | 10 | 5 | 10 | 5 | 4 | 10 | | | | | |
| retardant | Ammonium polyphosphate | | | | | | | 5 | | | | |
| | Melamine cyanurate | | | | | | | | 5 | 10 | | |
| | Melamine sulfate | | | | | | | | | | 5 | 10 |
| | Amine phosphate- | | | | | | | | | | | |
| | metal phosphate composite | | | | | | | | | | | |
| | Guanidine phosphate | | | | | | | | | | | |

| | | | | | | | | | | | |
|---|---|---|---|---|---|---|---|---|---|---|---|
| Combustion test | No | No | No | No | No | No | No | No | No | No | No |
| | flaming | flaming | flaming | flaming | flaming | flaming | flaming | flaming | flaming | flaming | flaming |
| Surface material peel strength of | 7.3 | 7.7 | 5.8 | 9.5 | 8.9 | 9.3 | 7.4 | 7.3 | 2.8 | 8.3 | 4.5 |
| metal-resin composite material | | | | | | | | | | | |
| (N/mm) | | | | | | | | | | | |

TABLE 2

| | | Example | Example | Example | Example | Example | Example | Example | Example | Example |
|---|---|---|---|---|---|---|---|---|---|---|
| | | 12 | 13 | 14 | 15 | 16 | 17 | 18 | 19 | 20 |
| Resin | PVB | | | 4.6 | 4.6 | 5 | 4.6 | 4.6 | 4.6 | 4.6 |
| | EVA | 4.6 | | | | | | | | |
| | Polyamide | | 4.6 | | | | | | | |
| Metal | Aluminum hydroxide | 90.4 | 90.4 | 70.4 | 80.4 | 80 | 45.4 | 35.4 | 40.4 | 50.4 |
| hydroxide | Magnesium hydroxide | | | 20 | 10 | 10 | | | | |
| Inorganic | CaCO₃ | | | | | | 20 | 20 | 25 | 20 |
| filler | MgCO₃ | | | | | | 20 | 30 | 25 | 20 |
| | Lightweight material | | | | | | | | | |
| Flame | Melamine polyphosphate | 5 | 5 | 5 | 5 | 5 | 10 | 10 | 5 | 5 |
| retardant | Ammonium polyphosphate | | | | | | | | | |
| | Melamine cyanurate | | | | | | | | | |
| | Melamine sulfate | | | | | | | | | |
| | Amine phosphate- | | | | | | | | | |
| | metal phosphate composite | | | | | | | | | |
| | Guanidine phosphate | | | | | | | | | |

| | | | | | | | | | |
|---|---|---|---|---|---|---|---|---|---|
| Combustion test | No | No | No | No | No | No | No | No | No |
| | flaming | flaming | flaming | flaming | flaming | flaming | flaming | flaming | flaming |
| Surface material peel strength of | 2.6 | 2.4 | 2.4 | 2.9 | 3.6 | 6.2 | 5.5 | 5.2 | 4.7 |
| metal-resin composite material | | | | | | | | | |
| (N/mm) | | | | | | | | | |

TABLE 3

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| Resin | PVB | 4.6 | 4.6 | 4.6 | 4.6 | 4.6 | 4.6 |
| | EVA | | | | | | |
| | Polyamide | | | | | | |
| Metal | Aluminum hydroxide | 75.4 | 75.4 | 95.4 | 90.4 | 85.4 | 90.4 |
| hydroxide | Magnesium hydroxide | | | | | | |
| Inorganic | CaCO₃ | 20 | | | | | |
| filler | MgCO₃ | | | | | | |
| | Lightweight material | | 20 | | | | |
| Flame | Melamine polyphosphate | | | | | | |
| retardant | Ammonium polyphosphate | | | | | | |
| | Melamine cyanurate | | | | | | |
| | Melamine sulfate | | | | | | |
| | Amine phosphate- | | | | 5 | 10 | |
| | metal phosphate composite | | | | | | |
| | Guanidine phosphate | | | | | | 5 |

| | | | | | | |
|---|---|---|---|---|---|---|
| Combustion test | Flaming | Flaming | Flaming | Flaming | Flaming | Flaming |
| Surface material peel strength of | 8.5 | 9.3 | 8.1 | 6.9 | 7.0 | 6.8 |
| metal-resin composite material | | | | | | |
| (N/mm) | | | | | | |

As shown in Tables 1 to 3, in the test piece made of the composition for a core material layer contained in each flame-retardant metal-resin composite material of Examples, no flaming was observed for 120 seconds after the test piece has been placed in the electric furnace and for 120 seconds after the test piece has been taken out from the electric furnace.

From this, it was found that the flame-retardant metal-resin composite material made using the composition for a core material layer has improved flame retardancy.

In the test piece made of the composition for a core material layer contained in each flame-retardant metal-resin composite material of Comparative Examples 1 to 3, continuous flaming was observed for at least one of the period of 120 seconds after the test piece has been placed in the electric furnace and the period of 120 seconds after the test piece has been taken out from the electric furnace.

The compositions for a core material layer of Comparative Examples 1 to 3 contain no flame retardant. From this, it was found that the flame-retardant metal-resin composite material made using the composition for a core material layer which contains no flame retardant has insufficient flame retardancy.

In the test piece made of the composition for a core material layer contained in each flame-retardant metal-resin composite material of Comparative Examples 4 to 6, continuous flaming was observed in at least one of the period of 120 seconds after the test piece has been placed in the electric furnace and the period of 120 seconds after the test piece has been taken out from the electric furnace.

The compositions for a core material layer of Comparative Examples 4 to 6 contain a flame retardant, but the amine phosphate-metal phosphate composite used in Comparative Examples 4 and 5 and the guanidine phosphate used in Comparative Example 6 are flame retardants of a different type from the flame retardant of the present invention. From this, it was found that in order to improve the flame retardancy of the flame-retardant metal-resin composite material, it is not sufficient to contain any flame retardant in the composition for a core material layer, but it is necessary to contain a specific flame retardant in the composition.

From the above, it was found that a flame-retardant metal-resin composite material with improved flame retardancy can be obtained by containing a specific flame retardant.

### INDUSTRIAL APPLICABILITY

The flame-retardant metal-resin composite material in accordance with an aspect of the present invention is excellent in flame retardancy and is useful, for example, as an exterior construction material such as an exterior wall material for buildings.

1. A flame-retardant metal-resin composite material comprising:
a core material layer; and
metal layers stacked on both surfaces of the core material layer, wherein
the core material layer contains
a metal hydroxide,
a resin having at least one polar group selected from the group consisting of a hydroxyl group, a carboxyl group, an aldehyde group, an amino group, a glycidyl group, and a ketone group, and
a flame retardant containing at least one selected from the group consisting of an inorganic polyphosphate compound, an inorganic phosphite compound, an inorganic phosphinate compound, an inorganic metaphosphate compound, a melamine compound, and a triazine compound.

2. The flame-retardant metal-resin composite material according to claim 1, wherein flaming for not shorter than 1 second does not occur at the core material layer for 120 seconds after the core material layer has been placed in an electric furnace and for 120 seconds after the core material layer has been taken out from the electric furnace in the following combustion test:
[combustion test]
a core material layer test piece of 38 mm in length, 38 mm in width, and 3 mm in height is placed in an electric furnace having a heater output of 500 W, internal furnace dimensions of 90 mm×110 mm×70 mm, and an inside controlled to 800° C. so that a 38 mm×38 mm surface of the core material layer test piece is substantially perpendicular to a bottom surface of the inside of the electric furnace.

3. The flame-retardant metal-resin composite material according to claim 1, wherein the metal-resin composite material has a surface material peel strength of not less than 2.4 N/mm.

4. The flame-retardant metal-resin composite material according to claim 1, wherein the resin is at least one resin selected from the group consisting of a polyvinyl alcohol-based resin, a polyamide-based resin, a modified polyolefin-based resin, an olefin-based copolymer, an acrylic resin, a polyurethane-based resin, and an epoxy-based resin.

5. The flame-retardant metal-resin composite material according to claim 1, further comprising an adhesive layer between the core material layer and each of the metal layers, wherein
the adhesive layer contains a resin having at least one polar group selected from the group consisting of a hydroxyl group, a carboxyl group, an aldehyde group, an amino group, a glycidyl group, and a ketone group.

6. The flame-retardant metal-resin composite material according to claim 5, wherein the resin contained in the adhesive layer is at least one resin selected from the group consisting of a polyvinyl alcohol-based resin, a polyamide-based resin, a modified polyolefin-based resin, an olefin-based copolymer, an acrylic resin, a polyurethane-based resin, and an epoxy-based resin.

7. The flame-retardant metal-resin composite material according to claim 1, comprising 1 to 15 parts by mass of the flame retardant with respect to 100 parts by mass of the core material layer.

8. The flame-retardant metal-resin composite material according to claim 7, comprising 1 part by mass to 10 parts by mass of the resin with respect to 100 parts by mass of the core material layer.

9. The flame-retardant metal-resin composite material according to claim 7, comprising 30 parts by mass to 95 parts by mass of the metal hydroxide with respect to 100 parts by mass of the core material layer.

10. The flame-retardant metal-resin composite material according to claim 1, further comprising a layer made of a non-woven fabric.
